(19) United States
(12) Patent Application Publication
(10) Pub. No.: US 2024/0242462 A1
(43) Pub. Date: Jul. 18, 2024

(54) GAME FOCUS ESTIMATION IN TEAM SPORTS FOR IMMERSIVE VIDEO

(71) Applicant: Intel Corporation, Santa Clara, CA (US)

(72) Inventors: Liwei Liao, Beijing (CN); Ming Lu, Beijing (CN); Xiaofeng Tong, Beijing (CN); Wenlong Li, Beijing (CN)

(73) Assignee: Intel Corporation, Santa Clara, CA (US)

(21) Appl. No.: 18/270,823

(22) PCT Filed: Feb. 2, 2021
(86) PCT No.: PCT/CN2021/074787

§ 371 Date: Jul. 3, 2023

(51) Int. Cl. G06V 10/25; G06T 7/246; G06T 7/292; G06V 10/82; G06V 20/40

(52) U.S. Cl. CPC G06V 10/25; G06T 7/246; G06T 7/292; G06V 10/82; G06V 20/42; G06V 20/46; G06T 2207/20072; G06T 2207/20084; G06T 2207/30196; G06T 2207/30224; G06T 2207/30242

(57) ABSTRACT

Techniques related to game focus estimation in team sports for multi-camera immersive video are discussed. Such techniques include selecting regions of a scene comprising a sporting event, generating a node graph and sets of features for the selected regions, and determining a game focus region of the selected regions by applying a graph node classification model based on the node graph and sets of features.

### BACKGROUND

In immersive video and other contexts such as computer vision applications, a number (e.g., dozens) of high resolution cameras are installed around a scene of interest. For example, cameras may be installed in a stadium around a playing field to capture a sporting event. Using video obtained from the cameras, a point cloud volumetric model or other 3D model representative of the scene is generated. A photo realistic view from a virtual view within the scene may then be generated using a view of the model that is painted with captured texture. Such views may be generated in every moment to provide an immersive experience for a user. Furthermore, the virtual view can be navigated in the 3D space to provide a multiple degree of freedom immersive user experience.

In such contexts, particularly for sporting scenes, it is critical for the system to be able to follow a sporting object (e.g., a ball) such that views of interest for the virtual camera may be generated. That is, the viewer typically has a strong interest in observing the sporting object and the action around the sporting object during the event. To follow the sporting object, object tracking (e.g., ball tracking) solutions are employed to determine the 3D location and movement of the object. However, in some contexts including team sports such as American football, soccer, and others, locating and tracking the ball is a difficult task due to occlusion, fast speed, and small size of the sporting object, and other concerns.

It is desirable to detect and track objects including small objects such as sporting objects in immersive video contexts such that a virtual view may be generated within a scene and for other purposes. It is with respect to these and other considerations that the present improvements have been needed. Such improvements may become critical as the desire to provide new and immersive user experiences in video becomes more widespread.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 illustrates an example system for locating a small object such as a sporting object in immersive video multi-camera systems;

FIG. 2 illustrates an example camera array trained on an example 3D scene;

FIG. 3 illustrates example person and object detection and recognition for multi-camera immersive video;

FIG. 4 illustrates example generation of multi-camera data from the collection and merger of single camera data across time instances;

FIG. 5 illustrates an example division of an example scene into a grid of regions;

FIG. 6 illustrates example region selection for use in graph node modeling for an example scene;

FIG. 7 illustrates another example region selection for use in graph node modeling for an example scene;

FIG. 8 illustrates example moving orientation votes feature determination for use as a feature in graph node modeling;

FIG. 9 illustrates example temporal shadow feature determination for use as a feature in graph node modeling;

FIG. 10 illustrates example graph node classification model training;

FIG. 11 is a flow diagram illustrating an example process for locating an object for immersive video;

FIG. 12 is an illustrative diagram of an example system for locating an object for immersive video;

FIG. 13 is an illustrative diagram of an example system; and

FIG. 14 illustrates an example device, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every embodiment may not necessarily include the particular feature, structure, or characteristic. Moreover, such phrases are not necessarily referring to the same implementation. Further, when a particular feature, structure, or characteristic is described in connection with an embodiment, it is submitted that it is within the knowledge of one skilled in the art to effect such feature, structure, or characteristic in connection with other implementations whether or not explicitly described herein.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

Methods, devices, apparatuses, computing platforms, and articles are described herein related to locating objects and game focus regions for immersive video contexts.

As described above, it is desirable to locate a potentially small and/or fast moving object (e.g., a sporting object) in a scene of a sporting context such that the object can be tracked and used for a variety of purposes such as generating a virtual view within the scene, detecting other persons or players in the scene, etc. person can be generated, and for other purposes. Herein, such object detection or locating such objects is presented in the context of sporting events and, in particular, in the context of American football for the sake of clarity of presentation. However, the discussed techniques may be applied, as applicable, in any context, sporting or otherwise. As used herein, the term sporting object indicates an object used in the sporting event such as a football, a soccer ball, a basketball, or, more generally, a ball, a puck, disc, and so on.

The techniques discussed herein provide location of a sporting object within a scene and, in particular, address heavy occlusion of a sporting object such as when the sporting object is not viewable from any camera location at one or more time instances. Such a location may be provided as a region of the scene such as a game focus region. As used herein, the term game focus region indicates a region deemed most likely to include a sporting object. The location may be used to locate and orient a virtual camera such that the virtual camera may follow the sporting object to show game action even when the sporting object is occluded. In some embodiments, a deep learning graph network or graph node classification model based approach is used to estimate a sporting object location when occlusion is heavy. Such locating of the sporting object may be characterized as game focus as it locates the focus of the sporting event or game. As used herein, the term graph node classification model indicates a network or other model that operates directly on graph data (i.e., node graphs) and is inclusive of graph convolutional networks (GCN) and graph neural networks (GNN).

In some embodiments, estimating game focus includes collecting raw data corresponding to the sporting event such as player locations, team identifications, jersey numbers, player velocities, movement orientation and location of the sporting object in each frame or time instance, and other data. Such data may be generated for a number of time instances each corresponding to a time instance for a number of frames or pictures attained of the scene for example. It is noted that the sporting object location may be output from sporting object detection and the location and/or movement orientation may be imprecise or even wrong when the sporting object is occluded and such sporting object detection may be supplemented with its moving trajectory in a temporal history. Such raw data is transformed to graph node classification model input data, which may include a node graph and a set of features for each node of the node graph. As used herein, the term node graph indicates a data structure representative of a number of nodes that are interconnected by edges (i.e., an edge extending between two nodes) and that may be provided to a graph node classification model such as a GCN, GNN, etc. As discussed herein, each node of the node graph corresponds to a region of the scene. For each node, a set of features is determined such that the features of each set are representative of or correspond to the sporting event being evaluated. The node graph and sets of features are then provided to a pretrained graph node classification model such as a GCN or GNN that performs node classification. The region of the scene corresponding to the node having the highest probability score as determined by the graph node classification model is then provided as an output region or game focus region deemed to include the sporting object. The output region (or a location therein such as a center location) may be used in any suitable manner such as training a virtual camera on the location, using the region as a focal point for image processing, and so on.

For example, in the context of American football, the field or gridiron may be divided into a grid of square or rectangular regions and selected ones of the regions (e.g., those regions having at least one player therein and/or a region deemed to have an airborne sporting object above it) are defined as nodes in a node graph. For each node, node features (e.g., features corresponding to American football and designed to provide accurate and robust classification by the graph node classification model such as a GCN or GNN) are generated, and the node graph and feature sets are provided to or fed to a pretrained graph node classification model such as DeepGCN to perform a node classification. Finally, a highest scoring region is output as a game focus region or location (e.g., the region deemed most likely to include the ball).

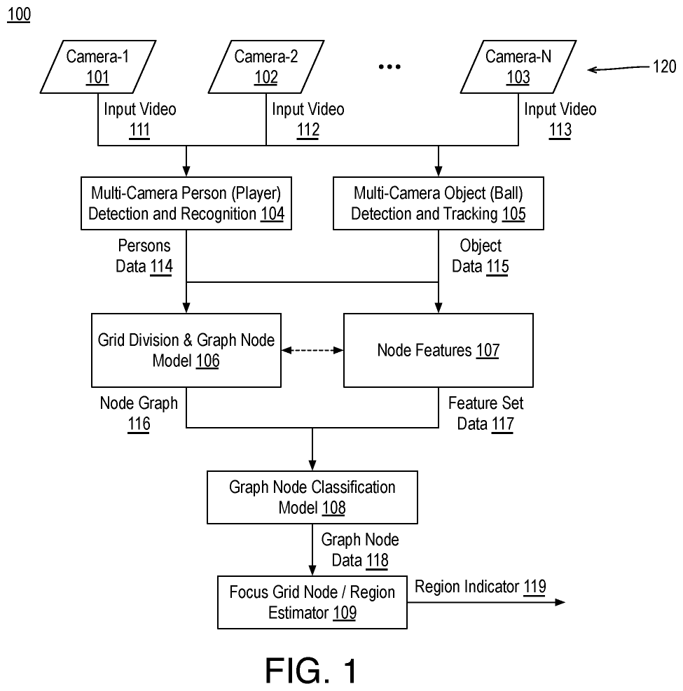

FIG. 1 illustrates an example system 100 for locating a small object such as a sporting object in immersive video multi-camera systems, arranged in accordance with at least some implementations of the present disclosure. System 100 may be implemented across any number of discrete devices in any suitable manner. In some embodiments, system 100 includes numerous cameras of a camera array 120 which are pre-installed in a stadium, arena, event location, etc., the same number of sub-servers or other compute resources to process the pictures or frames captured by the cameras of a camera array 120, and a main server or other compute resource to process the results of the sub-servers. In some embodiments, the sub-servers are employed as cloud resources.

In some embodiments, system 100 employs camera array 120 including individual cameras such as camera 101, camera 102, camera 103, and so on, a multi-camera person (e.g., player) detection and recognition module 104, a multi-camera object (e.g., ball) detection and tracking module 105, a grid division and graph node model module 106, a node features module 107, a graph node classification model 108, and a focus grid node and region estimator 109. For example, multi-camera person detection and recognition module 104 and multi-camera object detection and tracking module 105 may be characterized as a raw data collection component that collects player and ball information, grid division and graph node model module 106 and node features module 107 may be characterized as a graph modeling component that divides a sporting scene into a grid and transforms the raw data to graph data by taking selected grid regions as nodes and generating features for each node, and graph node classification model 108 and focus grid node and region estimator 109 may be characterized as a graph node classification model inference component that provides the graph data (e.g., node graph and feature sets) to the graph node classification model for inference and classification. System 100 may be implemented in any number of suitable form factor devices including one or more of a sub-server, a server, a server computer, a cloud computing environment, a personal computer, a laptop computer, a tablet, a phablet, a smart phone, a gaming console, a wearable device, a display device, an all-in-one device, a two-in-one device, or the like. Notably, in some embodiments, camera array 120 may be implemented separately from device(s) implementing the remaining components of system 100.

System 100 may begin operation based on a start signal or command (not shown) to being video capture and processing. Input video 111, 112, 113 captured via cameras 101, 102, 103 of camera array 120 includes contemporaneously or simultaneously attained or captured pictures of a scene. As used herein, the term contemporaneously or simultaneously captured video pictures indicates video pictures that are synchronized to be captured at the same or nearly the same time instance within a tolerance such as 300 ms. In some embodiments, the captured video pictures are captured as synchronized captured video. For example, the components of system 100 may be incorporated into any multi-camera multi-processor system to deliver immersive visual experiences for viewers of a scene.

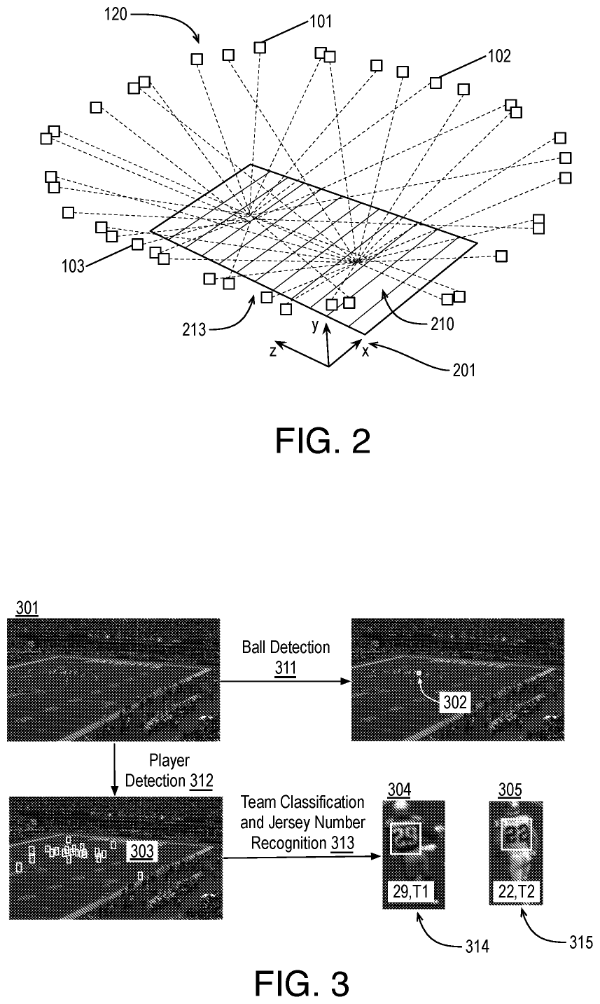

FIG. 2 illustrates an example camera array 120 trained on an example 3D scene 210, arranged in accordance with at least some implementations of the present disclosure. In the illustrated embodiment, camera array 120 includes 38 cameras (including cameras 101, 102, 103) trained on a sporting field. However, camera array 120 may include any suitable number of cameras trained on scene 210 such as not less than 20 cameras. For example, camera array 120 may be trained on scene 210 to capture video pictures for the eventual generation of a 3D model of scene 210 and fewer cameras may not provide adequate information to generate the 3D model. Furthermore, scene 210 may be any suitable scene such as a sport field, a sport court, a stage, an arena floor, etc. Camera array 120 may be mounted to a stadium (not shown) or other structure surrounding scene 210 and along the ground surrounding scene 210, calibrated, and trained on scene 210 to capture images or video. As shown, each camera of camera array 120 has a particular view of scene 210, which in operation includes a sporting event such as a game or match. For example, camera 101 has a first view of scene 210, camera 102 has a second view of scene 210, camera 103 has a third view of scene 210, and so on. As used herein, the term view indicates the image content of an image plane of a particular camera of camera array 120 or image content of any view from a virtual camera located within scene 210. Notably, the view may be a captured view (e.g., a view attained using image capture at a camera) such that multiple views include representations of the same person, object, entity, etc. Furthermore, each camera of camera array 120 has an image plane that corresponds to the image taken of scene 210.

Also as shown, a 3D coordinate system 201 is applied to scene 210. 3D coordinate system 201 may have an origin at any location and may have any suitable scale. Although illustrated with respect to a 3D Cartesian coordinate system, any 3D coordinate system may be used. Notably, it is one objective of system 100 to locate a sporting object within scene 210 using video sequences attained by the cameras of camera array 120 even when the sporting object is occluded from some or all of the cameras of camera array 120. As discussed further herein, scene 210 such as a playing area 213 (e.g., a field, court or the like) is divided into a number of regions such as by applying a square or rectangular grid on playing area 213. Particular ones of the regions (e.g., selected ones of candidate regions) are then determined based on characteristics of the sporting event occurring on playing area 213. For example, regions may be selected in response to (i.e., only if) a player within the region or the sporting object is detected as being above the region. For example, such regions are likely to include the sporting object. It is noted that an object being detected and/or tracked to a location above the region (or on the region, etc.) is not definitive as such detection and/or tracking can be inaccurate, can detect false positives, and so on. Such region selection from the candidate regions identifies those regions most likely to include the sporting object. As discussed further below, a node of a node graph is generated for each selected region and a set of features is also generated for each node and corresponding selected region. The node graph and corresponding sets of features are then provided to a graph node classification model such as a GCN or GNN to identify the selected region most likely to include the sporting object (i.e., the region the sporting object is most likely in, above, etc.). As used herein, the term sporting object being within a region indicates the x and y coordinates of the sporting object are within the region.

With reference to FIG. 1, each camera 101, 102, 103 of camera array 120 attains input video 111, 112, 113 (e.g., input video sequences including sequences of input pictures). Camera array 120 attains input video 111, 112, 113 each corresponding to a particular camera of camera array 120 to provide multiple views of scene 210. Input video 111, 112, 113 may include input video in any format and at any resolution. In some embodiments, input video 111, 112, 113 comprises 3-color channel video with each video picture having 3-color channels (e.g., RGB, YUV, YCbCr, etc.). Input video 111, 112, 113 is typically high resolution video such as 5120×3072 resolution. In some embodiments, input video 111, 112, 113 has a horizontal resolution of not less than 4000 pixels such that input video 111, 112, 113 is 4K or higher resolution video. As discussed, camera array 120 may include, for example 38 cameras. It is noted that the following techniques may be performed using all such cameras or a subset of the cameras. Herein the term video picture and video frame are used interchangeably. As discussed, the input to system 100 is streaming video data (i.e., real-time video data) at a particular frame rate such as 30 fps. The output of system 100 includes one or more indicators of key persons in a scene. In the following, the terms person or player, subgroup and team, and similar terms are used interchangeably without loss of generalization.

As shown, input video 111, 112, 113 is provided to multi-camera person detection and recognition module 104 and multi-camera object detection and tracking module 105. Multi-camera person detection and recognition module 104 generates persons (or players) data 114 using any suitable technique or techniques such as person detection techniques, person tracking techniques, and so on. Persons data 114 includes any data relevant to each detected person based on the context of the scene and event under evaluation. In some embodiments, persons data 114 includes a 3D location (coordinates) of each person in scene 210 with respect to 3D coordinate system 201 (please refer to FIG. 2). For example, for each person, an (x, y, z) location is provided.

In some embodiments, persons data 114 includes a team identification of each person (e.g., a team of each player) such as an indicator of team 1 or team 2, home team or away team, etc. Although discussed with respect to teams, any subgrouping of persons may be applied and such data may be characterized as subgroup identification (i.e., each person may be identified as a member of subgroup 1 or subgroup 2). In some embodiments, persons data 114 includes a unique identifier for each person (e.g., a player identifier) in the subgroup such as a jersey number. In some embodiments, persons data 114 includes a velocity of each person such as a motion vector of each person with respect to 3D coordinate system 201. In some embodiments, persons data 114 includes an acceleration of each person such as an acceleration vector of each person with respect to 3D coordinate system 201.

In some embodiments, persons data 114 includes an indication of whether a player is a key player (or a position or other indicator to indicate the player is a key player). As discussed, American football is used for exemplary purposes to describe the present techniques. However, such techniques are applicable to other sports such as rugby, soccer, handball, and so on and to other events such as plays, political rallies, and so on. In American football, key players include the quarterback (QB), running back(s) (RB), wide receiver(s) (WR), corner back(s) (CB), and safety(ies) although others may be used. Other sports and events have key persons particular to those sports and events. As used herein the term key player or person indicates a player or person more likely to come into contact with or handle a sporting object.

Multi-camera object detection and tracking module 105 generates sporting object (or ball) data 115 using any suitable technique or techniques such as object detection and tracking techniques, small object detection and tracking techniques, and so on. Object data 115 includes any data relevant to the detected sporting object based on the context of the scene and event under evaluation. In some embodiments, object data 115 includes a 3D location (coordinates) of the detected object with respect to 3D coordinate system 201. In some embodiments, object data 115 includes a velocity of the detected object such as a motion vector of each person with respect to 3D coordinate system 201. In some embodiments, object data 115 includes an acceleration of the detected object such as an acceleration vector of each person with respect to 3D coordinate system 201.

FIG. 3 illustrates example person and object detection and recognition for multi-camera immersive video, arranged in accordance with at least some implementations of the present disclosure. As shown, a video picture 301 is received for processing such that a video picture 301 includes a number of persons and a sporting object. Although illustrated with respect to a single video picture 301, the discussed techniques may be performed and merged using any number of video pictures from the same time instance and any number of temporally prior video pictures from the same or other views of the scene.

As shown, in a first processing pathway as illustrated with respect to ball detection operations 311, video picture 301 (and other video pictures as discussed) are processed to detect and locate a sporting object 302 in video picture 301 and the scene being captured by video picture 301. As discussed such techniques may include any suitable multi-camera object or ball detection, recognition, and tracking techniques. Furthermore, object data 115 corresponding to sporting object 302 as discussed with respect to FIG. 1 are generated using such techniques.

In a second processing pathway as illustrated with respect to player detection operations 312 and team classification and jersey number recognition operations 313, video picture 301 (and other video pictures as discussed) are processed to detect and locate a number of persons 303 (including players and referees in the context of video picture 301) in video picture 301 and the scene being captured by video picture 301. Furthermore, for all or some of the detected persons 303, a team classification and jersey number are identified as shown with respect to persons 304, 305. In the illustrated example, person 304 is a member of team 1 (T1) and has a jersey number of 29 and person 305 is a member of team 2 (T2) and has a jersey number of 22 as provided by person data 314, 315, respectively. For example, person data 314, 315 may make up a portion of persons data 114. Such player detection and team classification and jersey number recognition may include any suitable multi-camera person or player detection, recognition, team or subgroup classification, jersey number or person identification techniques and they may generate any person data discussed herein such as any components of persons data 114. Such techniques may include application of pretrained classifiers relevant to the particular event being captured. As discussed, person data 115 corresponding to persons 303 are generated using such techniques.

With reference to FIG. 1, as discussed, multi-camera person detection and recognition module 104 operates on pictures or frames from cameras of camera array 120 to generate and collect comprehensive information for players or persons including one or more of their 3D positions, jersey numbers, velocities, accelerations, movement orientations, and team identification using any computer vision and machine learning techniques.

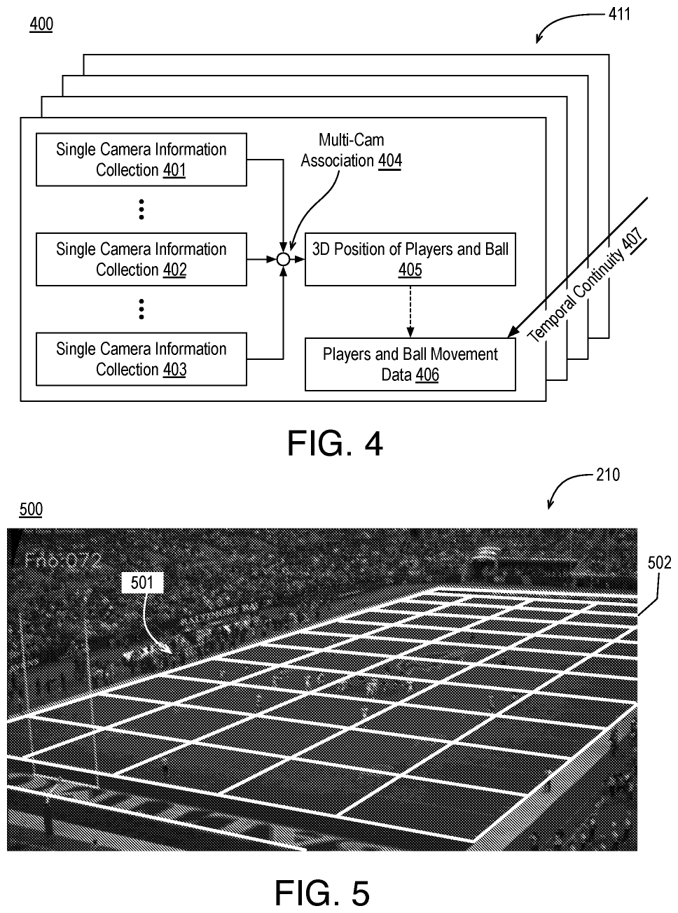

FIG. 4 illustrates example generation of multi-camera data from the collection and merger of single camera data across time instances, arranged in accordance with at least some implementations of the present disclosure. As shown, each of any number of single camera information collection modules 401, 402, 403 generates a 3D position of the players and sporting object. Such data is then merged via multi-camera association 404 to generate resultant 3D position of players and ball data 405 that includes a final or resultant 3D position for players and the sporting object. Furthermore, temporal continuity 407 across time instances 411 may be leveraged to refine such players and ball 3D position data and to generate players and ball movement data 406 including high level temporal data such as velocity, moving orientation, acceleration, and so on. Such techniques generate 3D position of players and ball data, player jersey numbers, velocities, accelerations, movement orientations, team identifications, ball velocity, acceleration, and movement direction, etc. as discussed herein. As shown in FIG. 4, single camera view of information is attained and refined (e.g., to improve accuracy) by associating all single camera information (e.g., to provide averaging, discarding of false positives, etc.) based on multi-camera ball detection and tracking, multi-camera player detection, team classification, jersey number recognition, and other techniques.

Returning to FIG. 1, such persons (or players) data 114 and sporting object (or ball) data 115 are provided to grid division and graph node model module 106 and node features module 107. Such modules provide graph modeling operations prior to classification using a graph node classification model. For example, grid division and graph node model module 106 and node features module 107 translates persons (or players) data 114 and sporting object (or ball) data 115 to graph structure data including a node graph and features for each node of the node graph.

As discussed further herein below, each selected region of a number of candidate regions is treated as a node in a graph or graphical representation for later application of a graph node classification model such as a GCN, a GNN, a graph attentional network (GAT), or other classifier. In some embodiments, a graph like data structure is generated as shown in Equation (1):

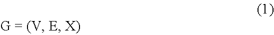

where V is the set of nodes and E is a set of edges (or connections) of the node graph (i.e., as defined by node graph data 116), and X is the set of node features (i.e., as defined by feature set data 117). Notably, herein a node is defined based on data within a selected region and an edge connects two nodes when the regions have a shared boundary therebetween. In some embodiments, X∈ [symbol] ^{n×d}. Next, assuming \vec{x}ᵢ∈X, \vec{x}ᵢ={x₁, x₂, . . . , x_{d}} with n indicating the number of nodes and d indicating the length of the feature set or vector of each node, \vec{x}ᵢ provides the feature set or vector (i.e., set of features for each node and corresponding region) of each node i. Next, with vᵢ∈V indicating a node and eᵢⱼ=(vᵢ,vⱼ)∈E indicating an edge, the adjacent matrix, A, is determined as an N×N matrix such that Aᵢⱼ=1 if eᵢⱼ∈E and Aᵢⱼ=0 if eᵢⱼ∉E. Thereby, the adjacent matrix, A, and the node features, X, define graph or graph like data that are suitable for classification using a GCN, a GNN, a GAT, or other suitable classifier. To apply graph node classification model, the nodes, V, and edges, E, and the features, X, for each node must be defined and generated.

To define the nodes and edges, grid division and graph node model module 106 divides scene 120 into a grid of regions (e.g., candidate regions) and selects regions (e.g., selected regions) from the grid of regions based on predefined criteria. In some embodiments, the selection is of those regions that include one or more players therein. In some embodiments, the selection includes regions that include one or more players therein or that include the sporting object above the region. The selected regions then define the nodes of the graph node and the edges are defined such that edges are provided between nodes that correspond to regions that share a boundary therebetween. The graph node is provided by node graph data 116, which may include any suitable data structure that defines nodes and edges for use by a graph node classification model. For each of the selected nodes (and corresponding regions), a set of features are generated. The set of features may be characterized as a feature set, a feature vector, features, or the like. Such features correspond to the sporting event of the scene and are predefined to provide suitable information for locating a sporting object. Such features are discussed further herein below and are defined by feature seta data 117, which may include any suitable data structure that defines features for use by a graph node classification model.

FIG. 5 illustrates an example division 500 of an example scene 210 into a grid of regions 501, arranged in accordance with at least some implementations of the present disclosure. As shown, scene 210 is divided into grid of regions 501 defined by boundaries 502 such that, for example, an entirety of a playing field or court is divided into contiguous regions. For example, grid division and graph node model module 106 divides scene 120 into grid of regions 501. In the example of American football, the playing field may be divided into a 5×12 grid of regions; however, any number of regions may be defined of any suitable size. Notably, grid of regions 501 may include regions that are defined by a portion of a plane in 3D coordinate system 201 and regions 501 may also include the volume extending above the portion of the plane. In the illustrated example, grid of regions 501 includes rectangular regions of the same size and shape that entirely fill the playing field. However, regions 501 may have any suitable size(s) and shape(s). Regions 501 may be characterized as candidate regions as particular regions of regions 501 will be selected for use in graph node modeling.

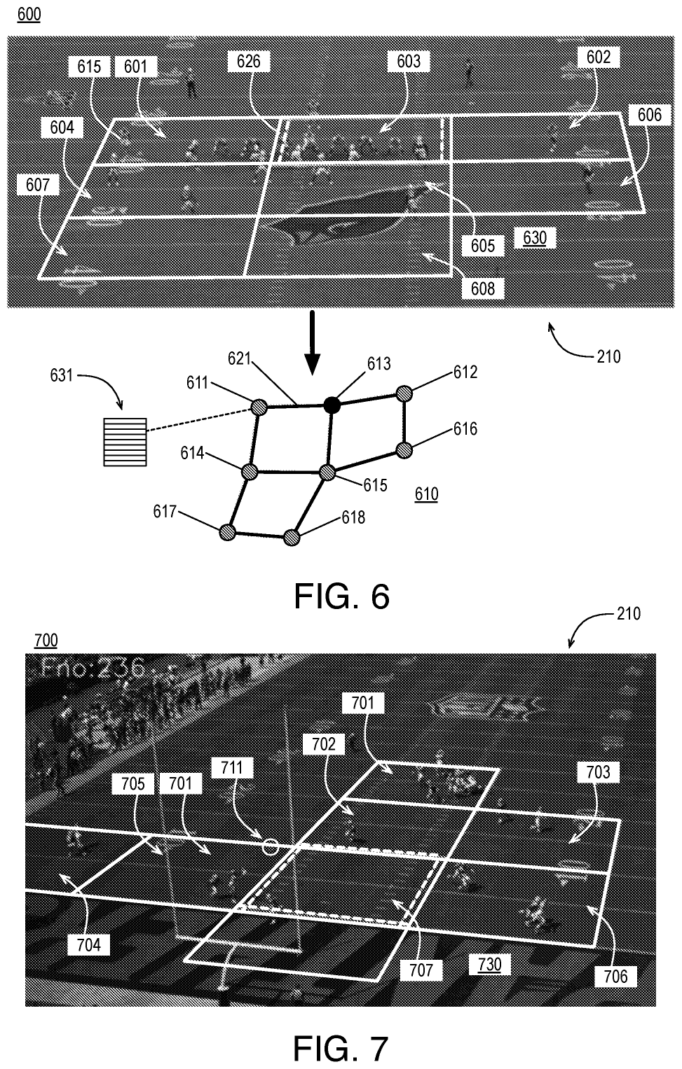

FIG. 6 illustrates example region selection 600 for use in graph node modeling for an example scene 210, arranged in accordance with at least some implementations of the present disclosure. As shown, for scene 210, a number of regions 630 are selected (e.g., selected regions 630) from grid of regions 501 based on selection criteria. For example, grid division and graph node model module 106 may select selected regions 630 from grid of regions 501 based on a predefined selection criteria. In the illustrated example, selected regions 630 include eight selected regions 601-608. However, any number of selected regions may be detected based on the selection criteria In some embodiments, the selection criteria is that at least one player is within the region as shown with respect to player 615 (and others) being within selected region 601. In some embodiments, the selection criteria is that at least one player is within the region or that the sporting object is above the region as discussed with respect to FIG. 7.

Based on the detected or selected regions, a node graph 610 is generated (as represented by node graph data 116) such that node graph 610 includes nodes 611-618 each corresponding to one of selected regions 601-608. For example, grid division and graph node model module 106 generates a node for each selected region. Furthermore, edges are defined between nodes 611-618 in response to a pair of nodes corresponding to selected regions 601-608 having a shared boundary therebetween. For example, edge 621 is generated between node 611 and node 613 in response to boundary 626 being shared by selected region 601 and selected region 604. Other edges (not labeled for the sake of clarity) are generated in a similar manner. As discussed further herein below, for each of nodes 611-618, a set of features, as illustrated with respect to set of features 631 of node 611) is determined such that the features correspond to or are relevant to the sporting event of scene 210. For example, features are defined based on preselected criteria or a predefined model and then the particular features for each region are generated based on the preselected criteria or predefined model as discussed herein below. In FIG. 6, although each of nodes 611-618 has a corresponding set of features, only a single set of features 631 is illustrated for the sake of clarity. Furthermore, in the example of FIG. 6, selected region 603 and node 613 are indicated using hatched lines and a black node color, respectively, to indicate the sporting object (ball) is within selected region 603. In a training phase such information may be used as ground truth and in implementation, it is the object of system 100 to locate sporting object (ball) within selected region 603 such that region 603 is identified as a game focus region.

FIG. 7 illustrates another example region selection 700 for use in graph node modeling for an example scene 210, arranged in accordance with at least some implementations of the present disclosure. As shown, for scene 210, a number of regions 730 are selected (e.g., selected regions 730) from grid of regions 501 based on particular selection criteria and, in particular, selection criteria including selection when a region has a player or is deemed to have sporting object 711 above the region. As noted, the location of sporting object 711 may be inaccurate or accurate. Including a region that is deemed to have sporting object 711 above the region eliminates the possibility of the region otherwise being discarded (e.g., due to the region not including any players) and improves accuracy of the graph node model.

For example, grid division and graph node model module 106 may select selected regions 730 from grid of regions 501 based on a predefined selection criteria including selection when at least one player is in the region or the sporting object 711 is deemed to be above the region. In the illustrated example, selected regions 701-706 are selected based on including one or more players and selected region 707 is selected based on sporting object 711 being detected to be above selected region 707. In some embodiments, the region is selected only when the object is deemed to be above the region by a particular threshold distance. For example, to handle the case of a sporting object (ball) in the air, a height threshold (e.g., of 2 meters) is set and, if ball_{height}>2 m, then the region the sporting object (ball) is above is included as a node regardless of whether any players are detected in the candidate region. Based on selected regions 730, a node graph is generated as discussed with respect to with respect to FIG. 6. Notably, the node graph generated for selected regions 730 has a different structure and shape with respect to node graph 610.

Returning to FIG. 1, such node graphs are generated by grid division and graph node model module 106 and output as node graph data 116. For each node in the node graph defined by node graph data 116, node features module 107 generates a set of features based on predefined feature criteria and outputs such sets of features as feature set data 117. The features for each node may be selected or defined based on the event being witnessed by camera array 120 within scene 210. For example, after attaining the node graph or graph structure, {V,E}, as defined by node graph data 116, features are prepared for each node corresponding to node features, X, such that, for each node i, feature set \vec{x}ᵢ∈X, \vec{x}ᵢ={x₁, x₂, . . . , x_{d}} is determined based on predefined criteria such that there are d features for each node.

Such feature sets may include any number of features such as five to 15 features or the like. The features discussed herein are relevant to many sporting events and are presented with respect to American football for the sake of clarity. In other sporting context some of the discussed features may be discarded and others may be added. Notably, the key players discussed herein presented with respect to American football may be defined for any suitable sporting event by one of skill in the art.

In some embodiments, the features for each node include one or more of a player quantity in the region (e.g., the number of players in the region), a maximum player velocity in the region (e.g., the maximum velocity of any player in the region), a mean player velocity in the region (e.g., a mean of the velocities of players in the region), a key player quantity in the region (e.g., the number of key players in the region), a maximum key player velocity in the region (e.g., the maximum velocity of any key player in the region), a mean key player velocity in the region (e.g., a mean of the velocities of key players in the region), an indicator of whether the sporting object is over the first region (e.g., an indicator of whether the ball is over the region), an indicator of whether the sporting object is in the air (e.g., an indicator of whether the ball is over any region), a number of players moving toward the region (e.g., a number of players moving in a movement direction within a threshold of a relative direction from the player to the first region), a temporal shadow value (e.g., a weight based on a relative position of the region to a collocated region corresponding to a game focus region for a prior time instance), a velocity sum vector for the x-axis (e.g., a decomposition along a first direction of a sum of all velocities in the region), and a velocity sum vector for the y-axis (e.g., a decomposition along a second direction, orthogonal to the first direction) of a sum of all velocities in the region). Other features may be used in addition or in the alternative to such features including a mean or minimum distance between players in the region, a maximum velocity difference between players in the region, a maximum acceleration of players in the region, or a mean acceleration of players in the region.

Table 1 illustrates an example set of features 0-11 for each node of a node graph, arranged in accordance with at least some implementations of the present disclosure.

TABLE 1
Example Features of Each Node

| Number | Feature Name | Notes |
|---|---|---|
| 0 | Player Quantity | How many players in the grid |
| 1 | Grid Max Velocity | Max velocity in the grid |
| 2 | Grid Mean Velocity | Mean velocity in the grid |
| 3 | Key Player Quantity | How many key players (QB, |
| | | RB, WR) |
| 4 | Grid Key Max Velocity | Max velocity of key players |
| 5 | Grid Key Mean Velocity | Mean velocity of key players |
| 6 | Ball Height Over 2 Meter | Judge if the ball is in the air |
| 7 | Moving Orientation | Judge how many players is |
| | Votes | orienting this gird |
| 8 | Velocity Vector Sum | Vector sum all velocity in the |
| | x-axis | grid and get x-axis decomposi- |
| | | tion |
| 9 | Velocity Vector Sum | get z-axis decomposition |
| | z-axis | |
| 10 | Temporal Shadow | Enhance the weights neighbor- |
| | | ing the last inferred grid |

As shown in Table 1, a feature set for a node and corresponding region may include one or more of player quantity (how many players in the grid region), grid max velocity (max velocity in the grid region), grid mean velocity (mean velocity in the grid), key player quantity (how many key players (QB, RB, WR, etc. in the grid region), grid key max velocity (max velocity of key players in the grid region), grid key mean velocity (mean velocity of key players in the grid region), ball height over threshold height such as 2 meter (judgment of whether the ball is in the air), moving orientation votes (judgment of how many players are moving in an orientation toward the grid region), velocity vector sum x-axis (vector sum all velocity in the grid and get x-axis decomposition), velocity vector sum z-axis (vector sum all velocity in the grid and get z-axis decomposition), temporal shadow (enhance the weights of region neighboring the last inferred game focus grid region).

Notably, the key players are defined based on the sporting event being evaluated. Such key players may be detected and tracked using any suitable technique or techniques. In American football, offensive key players that are include the quarterback (QB), running back(s) (RB), wide receiver(s) (WR) (who are all eligible receivers on the offensive team). Defensive key players include corner back(s) (CB), and safety(ies) (S) although others may be used. Other sports and events have key persons particular to those sports and events.

Discussion now turns to the moving orientation votes feature, which indicates a number of players moving in a movement direction within a threshold of a relative direction from the player to the region. The players evaluated for such moving orientation voting or summation may be all players or all players outside of the region. Notably, the feature is not based on only those players already in the region. For example, for each player, a direction toward the region may be defined (as a relative direction from the player to the first region or, simply, relative direction) and the movement direction of the player may be detected. The directions may then be compared and, if they are within a predefined threshold of one another, a vote or tally is applied for the feature of the region. All or some players are similarly evaluated and the total vote or tally is provided as the value for the moving orientation votes feature of the region. In some embodiments, the relative and movement directions are compared based on an angle therebetween and the angle is compared to a threshold. If the angle is less than the threshold (e.g., 45°), a tally or vote is counted and if not, no tally or vote is counted for the player.

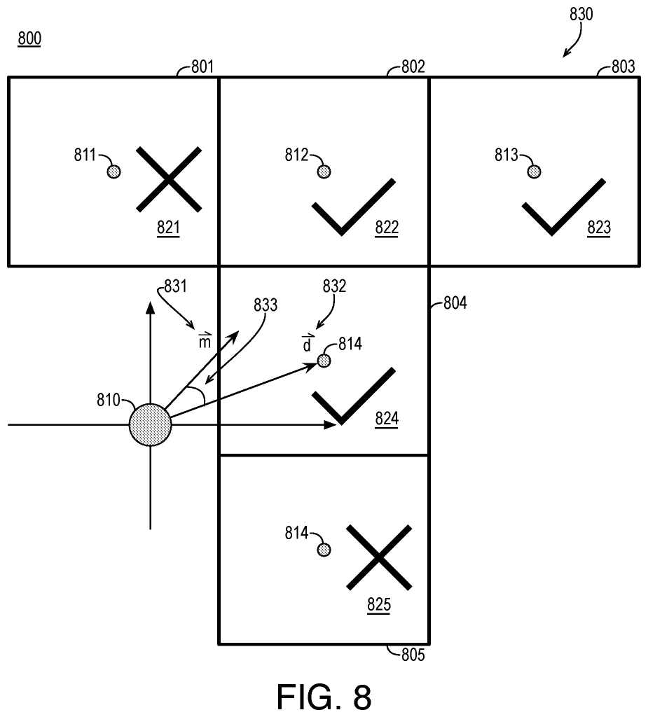

FIG. 8 illustrates example moving orientation votes feature determination 800 for use as a feature in graph node modeling, arranged in accordance with at least some implementations of the present disclosure. As shown, for each particular player and region combination, a determination is made as to whether a vote or tally is made for the region and player or not. Such operations are repeated for each player and region combination and the total number of votes or tallies for each region is the moving orientation votes feature for the region.

The operations for a player and region combination are illustrated with respect to player 810 and region 804. As shown, player 810 is moving in a movement direction 831. Movement direction 831 (nip) for player 810 may be detected using player detection and temporal tracking using any suitable technique or techniques. Furthermore, a relative direction 832 (\vec{d}_{gp}) for player 810 and region 804 is defined between the position of player 810 (e.g., as generated using player detection and tracking) and a position 814, such as a center position, of region 804. Although illustrated with respect to position 814 being a center position of region 804, any suitable position of region 804 may be used. As shown, an angle 833 between movement direction 831 and relative direction 832 is detected or defined. Angle 833 is then compared to a predefined threshold such as 45° and, if angle 833 is less than the threshold (or equal to or less than in some embodiments), player 810 is counted as a vote or tally for region 804. If not, player 810 is not counted as a vote or tally for region 804. In the illustrated example, since angle 833 is less than the threshold, player 810 is counted as a yes vote or tally 824 (as indicated by a check mark) for region 804.

Also as shown, player 810 is counted as a yes vote or tally 822 for region 802 based on an angle between movement direction 831 and a relative direction from player 810 to position 812 (not shown) being less than the threshold and player 810 is counted as a yes vote or tally 823 for region 803 based on an angle between movement direction 831 and a relative direction from player 810 to position 813 being less than the threshold. Notably, player 810 can be counted as a yes vote or tally for any number of regions. Furthermore, player 810 is counted as a no vote or tally 821 for region 801 based on an angle between movement direction 831 and a relative direction from player 810 to position 811 being greater than the threshold and as a no vote or tally 825 for region 805 based on an angle between movement direction 831 and a relative direction from player 810 to position 815 being greater than the threshold. Such operations are repeated for any number of players (i.e., all players or all players outside of the pertinent) for each region and the number of yes votes or tallies are counted and provided as the moving orientation votes feature for the region.

Such processing may be summarized as follows. For a grid region, g, initialize the moving orientation vote feature to zero (vote_{g}=0) and enumerate all on field players one by on based on an iterative counter value p. Given \vec{m}ₚ as the movement direction (e.g., moving or movement orientation) of player p and \vec{d}_{gp} as the relative direction (i.e., vector) from player p to a position such as a center of grid region g, the processing for the player and region combination is provided as shown in Equation (2):

$$If Angle ( {\vec{m}}_{p} , {\vec{d}}_{g p} ) < 45 ° then {vote}_{g} = {vote}_{g} + 1 \qquad ( 2 )$$

where Angle(\vec{m}ₚ, \vec{d}_{gp}) is the angle between the movement and relative directions and 45° is the example threshold. After processing all players, the moving orientation vote feature, vote_{g}, represents how many players are running toward grid region g, which is an important indicator of the importance, relative to being a game focus, for the region.

Discussion now turns to the temporal shadow feature, which provides a weight for a region based on the relative position between the region and a collocated region corresponding to a prior game focus region (e.g., for a prior time instance relative to a current time instance). In some embodiments, if the current region and the collocated region corresponding to a prior game focus region are matching regions, a highest score or weight is provided, if the current region and the collocated region corresponding to a prior game focus region are immediately adjacent and share a boundary (and, optionally, are aligned with or orthogonal to sidelines ore end lines of the sport field), a medium score or weight is provided, if the current region and the collocated region corresponding to a prior game focus region are immediately adjacent but do not share a boundary, a low score or weight is provided, and, otherwise, no weight or score is provided (e.g., a value of zero is used). As used herein, the term immediately adjacent regions indicate no intervening region is between the immediately adjacent regions.

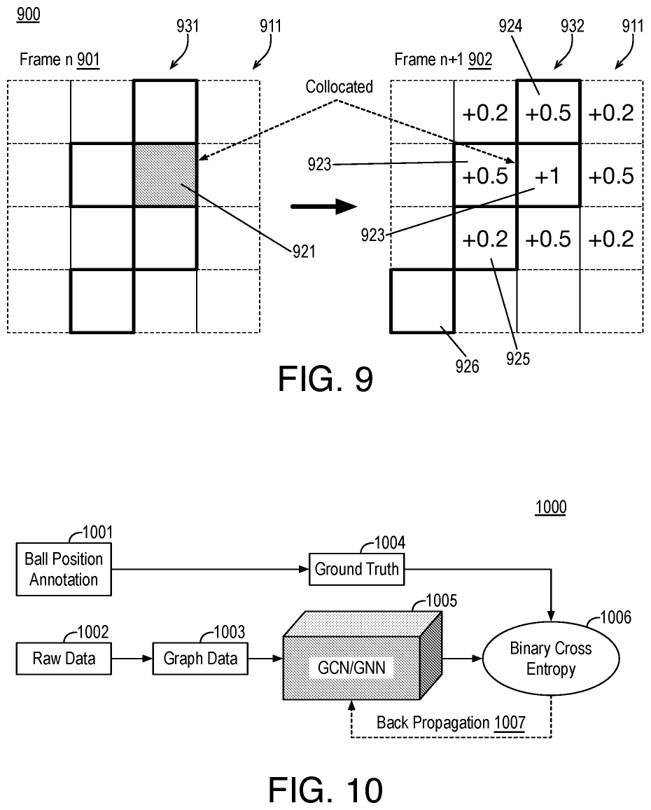

FIG. 9 illustrates example temporal shadow feature determination 900 for use as a feature in graph node modeling, arranged in accordance with at least some implementations of the present disclosure. As shown, for a time instance or frame n 901 (e.g., a prior time instance), selected regions 931 (as indicated by bold solid outline) may be selected from candidate grid regions 911 (inclusive of selected regions 931 and unselected regions as indicated by dashed outline) and a game focus region 921 may be determined using the techniques discussed herein.

For a time instance or frame n+1 902 (e.g., a current time instance), selected regions 932 (as indicated by bold solid outline) are selected from candidate grid regions 911 using the region selection techniques discussed herein. In some embodiments, for selected regions 932, a temporal shadow feature is determined as follows. A collocated region 923 corresponding to game focus region 921 is determined such that collocated region 923 is in the same spatial location in scene 210 as game focus region 921. It is noted that collocated region 923 may or may not be a selected region in time instance or frame n+1 902.

Based on collocated region 923, a temporal shadow feature score or weight is provided for other selected grid regions 932 for time instance or frame n+1 902. Example scores or weights are shown in time instance or frame n+1 902 for those regions that are not selected for the sake of clarity. As shown, for the region that matches collocated region 923, a highest value temporal shadow feature score or weight is applied (e.g., +1 in the example). For selected regions 924, 923 that are immediately adjacent to and share a boundary with collocated region 923, a second highest or medium score is applied (e.g., +0.5 in the example). For selected region 925, which is immediately adjacent to but does not share a boundary with collocated region 923, a lowest score is applied (e.g., +0.2 in the example). For all other regions (e.g., those that are not immediately adjacent to collocated region 923), no temporal shadow feature score or weight or a value of zero is applied as shown with respect to selected region 926.

Although illustrated with respect to a temporal shadow feature pattern that provides a highest score to a region matching the collocated region corresponding to the prior game focus region, medium scores to regions that are immediately adjacent to and share a boundary, low scores to regions that are immediately adjacent to but do not share a boundary, and no score otherwise, other patterns may be used. In some embodiments, a first score is provided for the matching region and all other immediately adjacent regions have a second score that is less than the first score. In some embodiments, a first score is provided for the matching region, all other immediately adjacent regions have a second score that is less than the first score, and a second level of adjacent regions have a third score that is less than the second score. Other patterns are available and may be dependent on the sporting event of scene 210.

Such techniques advantageously leverage the temporal continuity of game focus and prevent single frame error for smoother results. For example, based on temporal continuity, the weight of those nodes and regions that neighbor the last predicted game focus result can be promoted based on the consideration that the game focus region is unlikely to move significantly in the time between time instances or frames (e.g., 1/30 second for video at 30 frames per second).

Returning to FIG. 1, such node graph data 116 (e.g., node graph) and feature set data 117 (e.g., sets of features) are provided to graph node classification model 108. Graph node classification model 108 applies a pretrained graph node classification model to generate graph node data 118. Graph node classification model 108 may be any suitable model capable of processing graph node data and features to generate a characteristic or characteristics for the nodes. In some embodiments, graph node classification model 108 is a pretrained GCN. In some embodiments, graph node classification model 108 is a pretrained GNN. In some embodiments, graph node classification model 108 is a pretrained GAT.

Graph node data 118 may have any suitable data structure that indicates a likelihood for one or more nodes of the node graph represented by node graph data is a game focus and/or includes a sporting object. In some embodiments, graph node data 118 includes a likelihood score for each node of the node graph. Although discussed with respect to likelihood scores, other scores, values or characteristics may be employed.

Graph node data 118 are received by focus grid node and region estimator 109, which selects a node and corresponding region as a game focus node and game focus region and provides such data as region indicator 119. In some embodiments, focus grid node and region estimator 109 selects a region having a highest likelihood of being a game focus region. In some embodiments, region indicator 119 may be modified or adjusted based on temporal filtering (e.g., median filtering or the like) or other processing to provide a smoother game focus. Region indicator 119 may include any suitable data structure that indicates the current game focus region such as a region identifier. Region indicator 119 may be provided to other modules or components of system 100 for other processing such as object detection, generation of a virtual view, or the like.

FIG. 10 illustrates example graph node classification model training 1000, arranged in accordance with at least some implementations of the present disclosure. As shown, ball or sporting object position annotation 1001 may be performed to generate ground truth data 1004 for input data (not shown) for a variety of training instances pertinent to a scene and/or sporting event for which a graph node classification model 1005 (illustrated as a GCN or GNN) is being trained. Furthermore, for such input data may be used to generate raw data 1002 using the techniques discussed herein with respect to multi-camera person detection and recognition module 104 and multi-camera object detection and tracking module 105 and to generate graph data 1003 using the techniques discussed herein with respect to grid division and graph node model module 106 node features module 107. Notably, raw data 1002 corresponds to persons data 114 and object data 115 and graph data 1003 corresponds to node graph data 116 and feature set data 117. Such data are generated in the same manner such that the training and implementation phase of graph node classification model 1005 use data developed in the same manner.

Graph node classification model 1005 is the trained based on graph data 1003 and ground truth data 1004 by iteratively generating results using portions of graph data 1003, comparing the results to ground truth data 1004 and updating weights and parameters of graph node classification model 1005 using back propagation 1007. For example, as discussed, after translating raw data 1002 (e.g., persons data 114 and object data 115) to graph data 1003 (e.g., node graph data 116 and feature set data 117), the data are provided to a graph node classification model (e.g., a pretrained GCN, GNN, GAT, etc.) that learns high level representations from inputs. Herein, with reference to the discussion provided with respect to Equation (1), the adjacent matrix, A, and node features, X, are used to denote a graph-like same, which is provided to a graph node classification model as shown in Equation (3):

$$y = {f}_{G C N} ( A , X , W , b ) \qquad ( 3 )$$

where y denotes the final prediction of the a graph node classification model, f_{GCN}(⋅) denotes the graph node classification model, and W and b denote the weights and biases of the graph node classification model. In some embodiments, the DeepGCN may be employed as the graph node classification model as a binary classifier and binary cross entropy (BCE) 1006 loss is employed as the loss function.

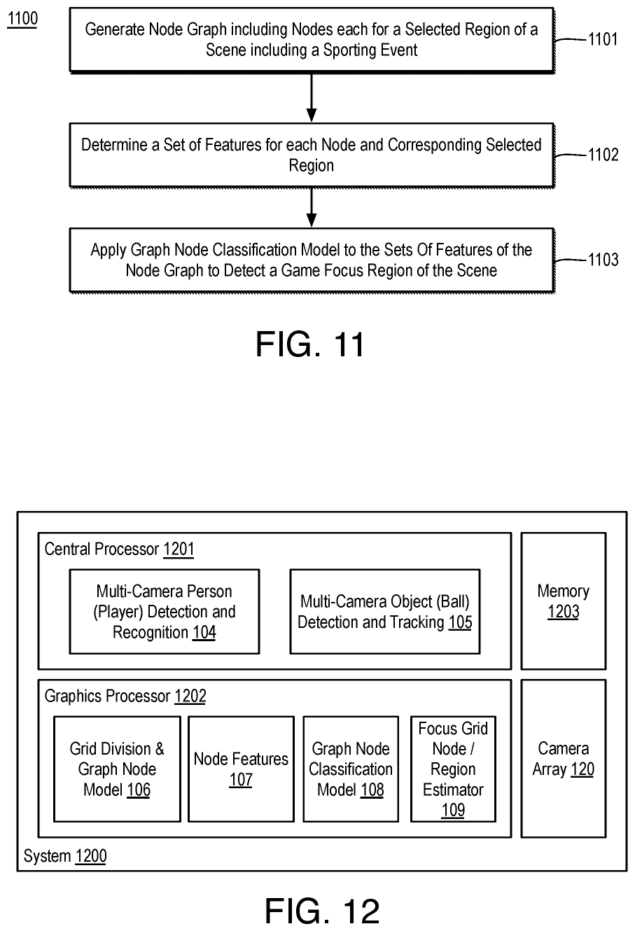

FIG. 11 is a flow diagram illustrating an example process 1100 for locating an object for immersive video, arranged in accordance with at least some implementations of the present disclosure. Process 1100 may include one or more operations 1101-1103 as illustrated in FIG. 11. Process 1100 may form at least part of a virtual view generation process, an object detection and/or tracking process, or the like in the context of immersive video or augmented reality, for example. By way of non-limiting example, process 1100 may form at least part of a process as performed by system 100 as discussed herein. Furthermore, process 1100 will be described herein with reference to system 1200 of FIG. 12.

FIG. 12 is an illustrative diagram of an example system 1200 for locating an object for immersive video, arranged in accordance with at least some implementations of the present disclosure. As shown in FIG. 12, system 1200 may include a central processor 1201, a graphics processor 1202, a memory 1203, and camera array 120. Also as shown, graphics processor 1202 may include or implement grid division and graph node model module 106, node features module 107, graph node classification model 108, and focus grid node and region estimator 109 and central processor 1201 may implement multi-camera person detection and recognition module 104 and multi-camera object detection and tracking module 105. In the example of system 1200, memory 1203 may store video sequences, video pictures, persons data, object data, features, feature sets, feature vectors, graph node model parameters, graph node data or any other data discussed herein.

As shown, in some examples, one or more or portions of grid division and graph node model module 106, node features module 107, graph node classification model 108, and focus grid node and region estimator 109 are implemented via graphics processor 1202 and one or more or portions of multi-camera person detection and recognition module 104 and multi-camera object detection and tracking module 105 are implemented via central processor 1201. In other examples, one or more or portions of multi-camera person detection and recognition module 104 and multi-camera object detection and tracking module 105, grid division and graph node model module 106, node features module 107, graph node classification model 108, and focus grid node and region estimator 109 are implemented via central processor 1201, an image processing unit, an image processing pipeline, an image signal processor, or the like. In some examples, one or more or portions of multi-camera person detection and recognition module 104 and multi-camera object detection and tracking module 105, grid division and graph node model module 106, node features module 107, graph node classification model 108, and focus grid node and region estimator 109 are implemented in hardware as a system-on-a-chip (SoC). In some examples, one or more or portions of multi-camera person detection and recognition module 104 and multi-camera object detection and tracking module 105, grid division and graph node model module 106, node features module 107, graph node classification model 108, and focus grid node and region estimator 109 are implemented in hardware via a FPGA.

Graphics processor 1202 may include any number and type of image or graphics processing units that may provide the operations as discussed herein. Such operations may be implemented via software or hardware or a combination thereof. For example, graphics processor 1202 may include circuitry dedicated to manipulate and/or analyze images obtained from memory 1203. Central processor 1201 may include any number and type of processing units or modules that may provide control and other high level functions for system 1200 and/or provide any operations as discussed herein. Memory 1203 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory 1203 may be implemented by cache memory. In an embodiment, one or more or portions of multi-camera person detection and recognition module 104 and multi-camera object detection and tracking module 105, grid division and graph node model module 106, node features module 107, graph node classification model 108, and focus grid node and region estimator 109 are implemented via an execution unit (EU) of graphics processor 1202. The EU may include, for example, programmable logic or circuitry such as a logic core or cores that may provide a wide array of programmable logic functions. In an embodiment, one or more or portions of multi-camera person detection and recognition module 104 and multi-camera object detection and tracking module 105, grid division and graph node model module 106, node features module 107, graph node classification model 108, and focus grid node and region estimator 109 are implemented via dedicated hardware such as fixed function circuitry or the like. Fixed function circuitry may include dedicated logic or circuitry and may provide a set of fixed function entry points that may map to the dedicated logic for a fixed purpose or function.

Returning to discussion of FIG. 11, process 1100 begins at operation 1101, where a node graph generated such that the node graph includes multiple nodes each corresponding to a selected region of a scene comprising a sporting event. The sporting event may be any sporting event such as an American football game, a rugby game, a basketball game, a soccer game, a handball game, and so on. The node graph may be generated using any suitable technique or techniques. In some embodiments, generating the node graph includes dividing the scene into a plurality of candidate regions, determining the selected regions based on at least one of the selected region including a player of the sporting event in the selected region or the sporting object over the selected region, and defining a node of the node graph for each of the selected regions. In some embodiments, determining the sporting object is over the selected region comprises comparing a current height of the sporting object to a threshold. In some embodiments, generating the node graph further comprises defining edges of the node graph only between selected regions of the scene that have a shared boundary therebetween.

Processing continues at operation 1102, where a set of features is determined for each node and corresponding selected region such that each set of features includes one or more features corresponding to the sporting event in the scene. The set of features may include feature values for any feature types discussed herein. The features employed may be the same number and type for each node or they may be different types and/or numbers of feature types. In some embodiments, the one or more features for a first set of features corresponding to a first selected region include at least one of a player quantity in the first selected region, a maximum or mean player velocity in the first selected region, a key player quantity in the first selected region, or a maximum or mean key player velocity in the first selected region. In some embodiments, the one or more features for the first set of features include an indicator of whether the sporting object is over the first region. In some embodiments, the one or more features for the first set of features include a number of players moving in a movement direction within a threshold of a relative direction from the player to the first region. In some embodiments, the one or more features for the first set of features include a weight based on a relative position of the first region to a collocated region corresponding to a second game focus region for a prior time instance. In some embodiments, the one or more features for the first set of features include a sum of first direction velocities of players in the first region and a sum of second direction velocities of the players in the first region, wherein the second direction is orthogonal to the first direction.

Processing continues at operation 1103, where a graph node classification model is applied to the sets of features of the node graph to detect a game focus region of the scene. The graph node classification model may be any suitable model pretrained using any suitable technique or techniques. In some embodiments, the graph node classification model is a pretrained graph convolutional network. In some embodiments, the graph node classification model is a pretrained graph neural network. In some embodiments, the graph node classification model is a graph attentional network.

Process 1100 may be repeated any number of times either in series or in parallel for any number of time instances. Process 1100 may be implemented by any suitable device(s), system(s), apparatus(es), or platform(s) such as those discussed herein. In an embodiment, process 1100 is implemented by a system or apparatus having a memory to store at least a portion of a graph node, as well as any other discussed data structures, and a processor to perform any of operations 1101-1103. In an embodiment, the memory and the processor are implemented via a monolithic field programmable gate array integrated circuit. As used herein, the term monolithic indicates a device that is discrete from other devices, although it may be coupled to other devices for communication and power supply.

Various components of the systems described herein may be implemented in software, firmware, and/or hardware and/or any combination thereof. For example, various components of the devices or systems discussed herein may be provided, at least in part, by hardware of a computing System-on-a-Chip (SoC) such as may be found in a computing system such as, for example, a smart phone. Those skilled in the art may recognize that systems described herein may include additional components that have not been depicted in the corresponding figures. For example, the systems discussed herein may include additional components that have not been depicted in the interest of clarity.

While implementation of the example processes discussed herein may include the undertaking of all operations shown in the order illustrated, the present disclosure is not limited in this regard and, in various examples, implementation of the example processes herein may include only a subset of the operations shown, operations performed in a different order than illustrated, or additional operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the devices or systems, or any other module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

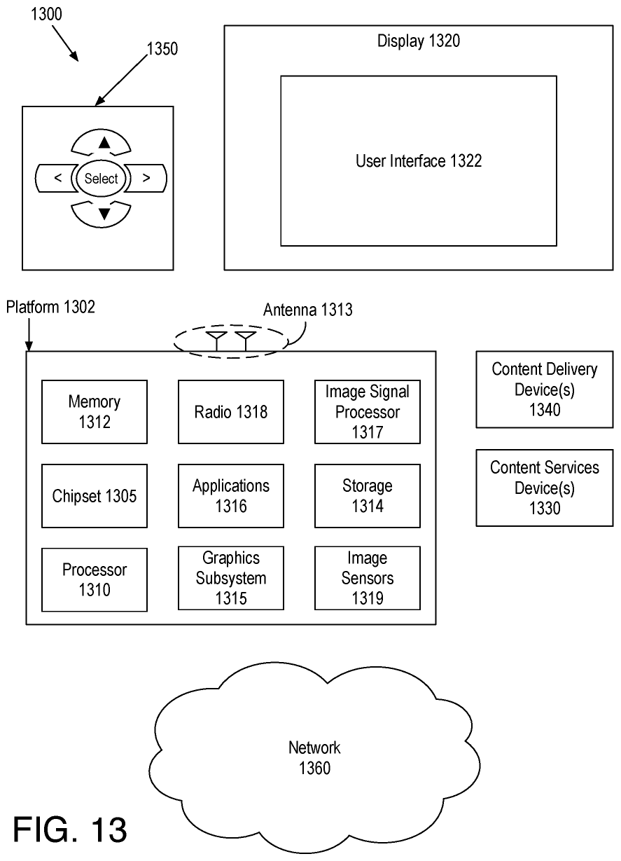

FIG. 13 is an illustrative diagram of an example system 1300, arranged in accordance with at least some implementations of the present disclosure. In various implementations, system 1300 may be a mobile device system although system 1300 is not limited to this context. For example, system 1300 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), a surveillance camera, a surveillance system including a camera, and so forth.

In various implementations, system 1300 includes a platform 1302 coupled to a display 1320. Platform 1302 may receive content from a content device such as content services device(s) 1330 or content delivery device(s) 1340 or other content sources such as image sensors 1319. For example, platform 1302 may receive image data as discussed herein from image sensors 1319 or any other content source. A navigation controller 1350 including one or more navigation features may be used to interact with, for example, platform 1302 and/or display 1320. Each of these components is described in greater detail below.

In various implementations, platform 1302 may include any combination of a chipset 1305, processor 1310, memory 1312, antenna 1313, storage 1314, graphics subsystem 1315, applications 1316, image signal processor 1317 and/or radio 1318. Chipset 1305 may provide intercommunication among processor 1310, memory 1312, storage 1314, graphics subsystem 1315, applications 1316, image signal processor 1317 and/or radio 1318. For example, chipset 1305 may include a storage adapter (not depicted) capable of providing intercommunication with storage 1314.

Processor 1310 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 1310 may be dual-core processor(s), dual-core mobile processor(s), and so forth.

Memory 1312 may be implemented as a volatile memory device such as, but not limited to, a Random Access Memory (RAM), Dynamic Random Access Memory (DRAM), or Static RAM (SRAM).

Storage 1314 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1314 may include technology to increase the storage performance enhanced protection for valuable digital media when multiple hard drives are included, for example.

Image signal processor 1317 may be implemented as a specialized digital signal processor or the like used for image processing. In some examples, image signal processor 1317 may be implemented based on a single instruction multiple data or multiple instruction multiple data architecture or the like. In some examples, image signal processor 1317 may be characterized as a media processor. As discussed herein, image signal processor 1317 may be implemented based on a system on a chip architecture and/or based on a multi-core architecture.

Graphics subsystem 1315 may perform processing of images such as still or video for display. Graphics subsystem 1315 may be a graphics processing unit (GPU) or a visual processing unit (VPU), for example. An analog or digital interface may be used to communicatively couple graphics subsystem 1315 and display 1320. For example, the interface may be any of a High-Definition Multimedia Interface, DisplayPort, wireless HDMI, and/or wireless HD compliant techniques. Graphics subsystem 1315 may be integrated into processor 1310 or chipset 1305. In some implementations, graphics subsystem 1315 may be a stand-alone device communicatively coupled to chipset 1305.

The graphics and/or video processing techniques described herein may be implemented in various hardware architectures. For example, graphics and/or video functionality may be integrated within a chipset. Alternatively, a discrete graphics and/or video processor may be used.

As still another implementation, the graphics and/or video functions may be provided by a general purpose processor, including a multi-core processor. In further embodiments, the functions may be implemented in a consumer electronics device.

Radio 1318 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1318 may operate in accordance with one or more applicable standards in any version.

In various implementations, display 1320 may include any television type monitor or display. Display 1320 may include, for example, a computer display screen, touch screen display, video monitor, television-like device, and/or a television. Display 1320 may be digital and/or analog. In various implementations, display 1320 may be a holographic display. Also, display 1320 may be a transparent surface that may receive a visual projection. Such projections may convey various forms of information, images, and/or objects. For example, such projections may be a visual overlay for a mobile augmented reality (MAR) application. Under the control of one or more software applications 1316, platform 1302 may display user interface 1322 on display 1320.

In various implementations, content services device(s) 1330 may be hosted by any national, international and/or independent service and thus accessible to platform 1302 via the Internet, for example. Content services device(s) 1330 may be coupled to platform 1302 and/or to display 1320. Platform 1302 and/or content services device(s) 1330 may be coupled to a network 1360 to communicate (e.g., send and/or receive) media information to and from network 1360. Content delivery device(s) 1340 also may be coupled to platform 1302 and/or to display 1320.

Image sensors 1319 may include any suitable image sensors that may provide image data based on a scene. For example, image sensors 1319 may include a semiconductor charge coupled device (CCD) based sensor, a complimentary metal-oxide-semiconductor (CMOS) based sensor, an N-type metal-oxide-semiconductor (NMOS) based sensor, or the like. For example, image sensors 1319 may include any device that may detect information of a scene to generate image data.

In various implementations, content services device(s) 1330 may include a cable television box, personal computer, network, telephone, Internet enabled devices or appliance capable of delivering digital information and/or content, and any other similar device capable of uni-directionally or bi-directionally communicating content between content providers and platform 1302 and/display 1320, via network 1360 or directly. It will be appreciated that the content may be communicated uni-directionally and/or bi-directionally to and from any one of the components in system 1300 and a content provider via network 1360. Examples of content may include any media information including, for example, video, music, medical and gaming information, and so forth.

Content services device(s) 1330 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1302 may receive control signals from navigation controller 1350 having one or more navigation features. The navigation features of navigation controller 1350 may be used to interact with user interface 1322, for example. In various embodiments, navigation controller 1350 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of navigation controller 1350 may be replicated on a display (e.g., display 1320) by movements of a pointer, cursor, focus ring, or other visual indicators displayed on the display. For example, under the control of software applications 1316, the navigation features located on navigation controller 1350 may be mapped to virtual navigation features displayed on user interface 1322, for example. In various embodiments, navigation controller 1350 may not be a separate component but may be integrated into platform 1302 and/or display 1320. The present disclosure, however, is not limited to the elements or in the context shown or described herein.

In various implementations, drivers (not shown) may include technology to enable users to instantly turn on and off platform 1302 like a television with the touch of a button after initial boot-up, when enabled, for example. Program logic may allow platform 1302 to stream content to media adaptors or other content services device(s) 1330 or content delivery device(s) 1340 even when the platform is turned “off.” In addition, chipset 1305 may include hardware and/or software support for 5.1 surround sound audio and/or high definition 7.1 surround sound audio, for example. Drivers may include a graphics driver for integrated graphics platforms. In various embodiments, the graphics driver may comprise a peripheral component interconnect (PCI) Express graphics card.

In various implementations, any one or more of the components shown in system 1300 may be integrated. For example, platform 1302 and content services device(s) 1330 may be integrated, or platform 1302 and content delivery device(s) 1340 may be integrated, or platform 1302, content services device(s) 1330, and content delivery device(s) 1340 may be integrated, for example. In various embodiments, platform 1302 and display 1320 may be an integrated unit. Display 1320 and content service device(s) 1330 may be integrated, or display 1320 and content delivery device(s) 1340 may be integrated, for example. These examples are not meant to limit the present disclosure.

In various embodiments, system 1300 may be implemented as a wireless system, a wired system, or a combination of both. When implemented as a wireless system, system 1300 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1300 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1302 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 13.

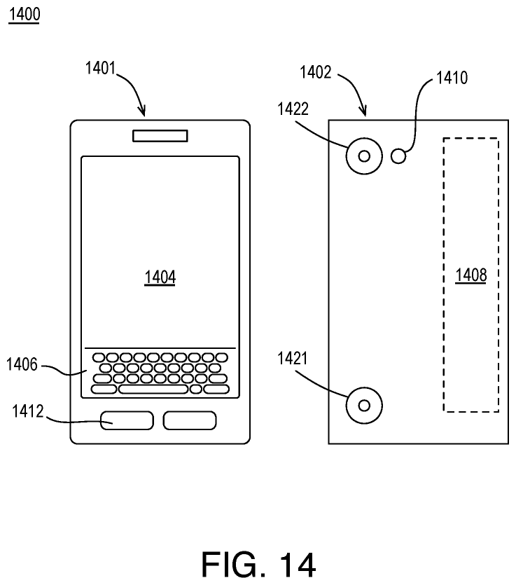

As described above, system 1300 may be embodied in varying physical styles or form factors. FIG. 14 illustrates an example small form factor device 1400, arranged in accordance with at least some implementations of the present disclosure. In some examples, system 1400 may be implemented via device 1400. In other examples, other systems, components, or modules discussed herein or portions thereof may be implemented via device 1400. In various embodiments, for example, device 1400 may be implemented as a mobile computing device a having wireless capabilities. A mobile computing device may refer to any device having a processing system and a mobile power source or supply, such as one or more batteries, for example.

Examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, smart device (e.g., smartphone, smart tablet or smart mobile television), mobile internet device (MID), messaging device, data communication device, cameras (e.g. point-and-shoot cameras, super-zoom cameras, digital single-lens reflex (DSLR) cameras), and so forth.

Examples of a mobile computing device also may include computers that are arranged to be implemented by a motor vehicle or robot, or worn by a person, such as wrist computers, finger computers, ring computers, eyeglass computers, belt-clip computers, arm-band computers, shoe computers, clothing computers, and other wearable computers. In various embodiments, for example, a mobile computing device may be implemented as a smartphone capable of executing computer applications, as well as voice communications and/or data communications. Although some embodiments may be described with a mobile computing device implemented as a smartphone by way of example, it may be appreciated that other embodiments may be implemented using other wireless mobile computing devices as well. The embodiments are not limited in this context.

As shown in FIG. 14, device 1400 may include a housing with a front 1401 and a back 1402. Device 1400 includes a display 1404, an input/output (I/O) device 1406, a color camera 1421, a color camera 1422, an infrared transmitter 1423, and an integrated antenna 1408. In some embodiments, color camera 1421 and color camera 1422 attain planar images as discussed herein. In some embodiments, device 1400 does not include color camera 1421 and 1422 and device 1400 attains input image data (e.g., any input image data discussed herein) from another device. Device 1400 also may include navigation features 1412. I/O device 1406 may include any suitable I/O device for entering information into a mobile computing device. Examples for I/O device 1406 may include an alphanumeric keyboard, a numeric keypad, a touch pad, input keys, buttons, switches, microphones, speakers, voice recognition device and software, and so forth. Information also may be entered into device 1400 by way of microphone (not shown), or may be digitized by a voice recognition device. As shown, device 1400 may include color cameras 1421, 1422, and a flash 1410 integrated into back 1402 (or elsewhere) of device 1400. In other examples, color cameras 1421, 1422, and flash 1410 may be integrated into front 1401 of device 1400 or both front and back sets of cameras may be provided. Color cameras 1421, 1422 and a flash 1410 may be components of a camera module to originate color image data with IR texture correction that may be processed into an image or streaming video that is output to display 1404 and/or communicated remotely from device 1400 via antenna 1008 for example.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as IP cores may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following pertain to further embodiments.

In one or more first embodiments, a method for locating an object for immersive video comprises generating a node graph comprising a plurality of nodes each corresponding to a selected region of a scene comprising a sporting event, determining a set of features for each node and corresponding selected region, each set of features comprising one or more features corresponding to the sporting event in the scene, and applying a graph node classification model to the sets of features of the node graph to detect a game focus region of the scene.

In one or more second embodiments, further to the first embodiment, generating the node graph comprises dividing the scene into a plurality of candidate regions, determining the selected regions based on at least one of the selected region comprising a player of the sporting event in the selected region or the sporting object over the selected region, and defining a node of the node graph for each of the selected regions.

In one or more third embodiments, further to the first or second embodiments, determining the sporting object is over the selected region comprises comparing a current height of the sporting object to a threshold.

In one or more fourth embodiments, further to any of the first through third embodiments, generating the node graph further comprises defining edges of the node graph only between selected regions of the scene that have a shared boundary therebetween.

In one or more fifth embodiments, further to any of the first through fourth embodiments, the one or more features for a first set of features corresponding to a first selected region comprise at least one of a player quantity in the first selected region, a maximum or mean player velocity in the first selected region, a key player quantity in the first selected region, or a maximum or mean key player velocity in the first selected region.

In one or more sixth embodiments, further to any of the first through fifth embodiments, the one or more features for the first set of features further comprises an indicator of whether the sporting object is over the first region.

In one or more seventh embodiments, further to any of the first through sixth embodiments, the one or more features for the first set of features further comprises a number of players moving in a movement direction within a threshold of a relative direction from the player to the first region.

In one or more eighth embodiments, further to any of the first through seventh embodiments, the one or more features for the first set of features further comprises a weight based on a relative position of the first region to a collocated region corresponding to a second game focus region for a prior time instance.

In one or more ninth embodiments, further to any of the first through eighth embodiments, the one or more features for the first set of features further comprises a sum of first direction velocities of players in the first region and a sum of second direction velocities of the players in the first region, wherein the second direction is orthogonal to the first direction.

In one or more tenth embodiments, further to any of the first through ninth embodiments, the graph node classification model comprises one of a pretrained graph convolutional network or a pretrained graph neural network.

In one or more eleventh embodiments, a device or system includes a memory and one or more processors to perform a method according to any one of the above embodiments.

In one or more twelfth embodiments, at least one machine readable medium includes a plurality of instructions that in response to being executed on a computing device, cause the computing device to perform a method according to any one of the above embodiments.

In one or more thirteenth embodiments, an apparatus includes means for performing a method according to any one of the above embodiments.

It will be recognized that the embodiments are not limited to the embodiments so described, but can be practiced with modification and alteration without departing from the scope of the appended claims. For example, the above embodiments may include specific combination of features. However, the above embodiments are not limited in this regard and, in various implementations, the above embodiments may include the undertaking only a subset of such features, undertaking a different order of such features, undertaking a different combination of such features, and/or undertaking additional features than those features explicitly listed. The scope of the embodiments should, therefore, be determined with reference to the appended claims, along with the full scope of equivalents to which such claims are entitled.

What is claimed is:

1. A system comprising:
a memory to store at least a portion of a node graph comprising a plurality of nodes each corresponding to a selected region of a scene comprising a sporting event; and
one or more processors coupled to the memory, the one or more processors to:
determine a set of features for each node and corresponding selected region, each set of features comprising one or more features corresponding to the sporting event in the scene; and
apply a graph node classification model to the sets of features of the node graph to detect a game focus region of the scene.

2. The system of claim 1, wherein the one or more processors to generate the node graph comprises the one or more processors to:
divide the scene into a plurality of candidate regions;
determine the selected regions based on at least one of the selected region comprising a player of the sporting event in the selected region or the sporting object over the selected region; and
define a node of the node graph for each of the selected regions.

3. The system of claim 2, wherein the one or more processors to determine the sporting object is over the selected region comprises the one or more processors to compare a current height of the sporting object to a threshold.

4. The system of claim 2, wherein the one or more processors to generate the node graph further comprises the one or more processors to define edges of the node graph only between selected regions of the scene that have a shared boundary therebetween.

5. The system of claim 1, wherein the one or more features for a first set of features corresponding to a first selected region comprise at least one of a player quantity in the first selected region, a maximum or mean player velocity in the first selected region, a key player quantity in the first selected region, or a maximum or mean key player velocity in the first selected region.

6. The system of claim 5, wherein the one or more features for the first set of features further comprises an indicator of whether the sporting object is over the first region.

7. The system of claim 5, wherein the one or more features for the first set of features further comprises a number of players moving in a movement direction within a threshold of a relative direction from the player to the first region.

8. The system of claim 5, wherein the one or more features for the first set of features further comprises a weight based on a relative position of the first region to a collocated region corresponding to a second game focus region for a prior time instance.

9. The system of claim 5, wherein the one or more features for the first set of features further comprises a sum of first direction velocities of players in the first region and a sum of second direction velocities of the players in the first region, wherein the second direction is orthogonal to the first direction.

10. The system of claim 1, wherein the graph node classification model comprises one of a pretrained graph convolutional network or a pretrained graph neural network.

11. A method comprising:
generating a node graph comprising a plurality of nodes each corresponding to a selected region of a scene comprising a sporting event;
determining a set of features for each node and corresponding selected region, each set of features comprising one or more features corresponding to the sporting event in the scene; and
applying a graph node classification model to the sets of features of the node graph to detect a game focus region of the scene.

12. The method of claim 11, wherein generating the node graph comprises:
dividing the scene into a plurality of candidate regions;
determining the selected regions based on at least one of the selected region comprising a player of the sporting event in the selected region or the sporting object over the selected region; and
defining a node of the node graph for each of the selected regions.

13. The method of claim 11, wherein the one or more features for a first set of features corresponding to a first selected region comprise at least one of a player quantity in the first selected region, a maximum or mean player velocity in the first selected region, a key player quantity in the first selected region, or a maximum or mean key player velocity in the first selected region.

14. The method of claim 13, wherein the one or more features for the first set of features further comprises a number of players moving in a movement direction within a threshold of a relative direction from the player to the first region.

15. The method of claim 13, wherein the one or more features for the first set of features further comprises a weight based on a relative position of the first region to a collocated region corresponding to a second game focus region for a prior time instance.

16. At least one machine readable medium comprising a plurality of instructions that, in response to being executed on a computing device, cause the computing device to locate an object for immersive video by:
generating a node graph comprising a plurality of nodes each corresponding to a selected region of a scene comprising a sporting event;
determining a set of features for each node and corresponding selected region, each set of features comprising one or more features corresponding to the sporting event in the scene; and
applying a graph node classification model to the sets of features of the node graph to detect a game focus region of the scene.

17. The machine readable medium of claim 16, wherein generating the node graph comprises:
dividing the scene into a plurality of candidate regions;
determining the selected regions based on at least one of the selected region comprising a player of the sporting event in the selected region or the sporting object over the selected region; and
defining a node of the node graph for each of the selected regions.

18. The machine readable medium of claim 16, wherein the one or more features for a first set of features corresponding to a first selected region comprise at least one of a player quantity in the first selected region, a maximum or mean player velocity in the first selected region, a key player quantity in the first selected region, or a maximum or mean key player velocity in the first selected region.

19. The machine readable medium of claim 18, wherein the one or more features for the first set of features further comprises a number of players moving in a movement direction within a threshold of a relative direction from the player to the first region.

20. The machine readable medium of claim 18, wherein the one or more features for the first set of features further comprises a weight based on a relative position of the first region to a collocated region corresponding to a second game focus region for a prior time instance.
